(19) United States
(12) Patent Application Publication
(10) Pub. No.: US 2017/0091802 A1
(43) Pub. Date: Mar. 30, 2017

(54) METHODS AND SYSTEMS FOR TRANSMITTING DATA INDICATIVE OF SELECTED VALUE ADDED SERVICES FROM OFFER DISTRIBUTION SERVERS TO MOBILE TERMINALS

(71) Applicant: MASTERCARD ASIA/PACIFIC PTE. LTD., Singapore (SG)

(72) Inventors: Jiaming Li, Singapore (SG); Sin Jian Tan, Singapore (SG); Jie Zhang, Singapore (SG); Bensam Joyson, SIngapore (SG); Ariel Hui Luan Poh, Singapore (SG)

(21) Appl. No.: 15/272,929

(22) Filed: Sep. 22, 2016

(30) Foreign Application Priority Data
Sep. 25, 2015 (SG) 10201507982S

(51) Int. Cl. G06Q 30/02; H04L 29/06; G06Q 20/34; G06Q 20/36; H04W 4/20; H04M 17/00

(52) U.S. Cl. CPC G06Q 30/0226; H04W 4/20; H04M 17/106; G06Q 30/0267; G06Q 20/34; G06Q 20/36; H04L 67/42; H04M 2017/14

(57) ABSTRACT

A method for transmitting data indicative of selected value added services includes: retrieving, from issuer servers, data indicative of value added services, offered by the issuer servers, for storage at the offer distribution server as value added services data; receiving, from a mobile terminal, wallet data providing an indication of payment cards stored in the mobile terminal; processing, at the offer distribution server, the wallet data against the value added services data to determine the value added services accessible through the mobile terminal by ascertaining that the payment cards are recognised by the respective issuer server that offers the value added services; extracting, at the offer distribution server, the selected value added services data for transmission to the mobile terminal in response to consolidation of the value added services accessible through the mobile terminal; and transmitting the selected value added services data to the mobile terminal.

### FIELD

The present disclosure relates broadly, but not exclusively, to methods and systems for transmitting data indicative of selected value added services from an offer distribution server to a mobile terminal.

### BACKGROUND

This section provides background information related to the present disclosure which is not necessarily prior art.

The capabilities of smart phones, or mobile phones with an advanced mobile operating system, are increasingly being tapped by merchants to sell their goods or services or both. Smart phones and other handheld computing devices such as tablets (also referred to herein as “mobile terminals”) are useful to merchants because such mobile terminals are able to host applications (“mobile applications”) that allow for electronic payment of goods and/or services, through the use of digital wallet technology; as well as being able to support value added services, which include coupons or offers, and loyalty programs. Examples of a coupon or offer are a ticket or document that can be exchanged for a financial discount or rebate when purchasing a product and/or service; or the awarding of points into a loyalty program.

Merchants have sought to capitalise on the penetration of such smart phones by using them to advertise promotions. One example of such usage is to have a server transmit advertisements of available value added services to a mobile terminal that executes an application developed under the sponsorship of a merchant where the value added services are redeemable. Such untargeted advertising of value added services may result in sending notifications of value added services in which the user of the mobile terminal has no interest. This may have the undesired consequence of the user deactivating the feature in the application that allows advertisements of value added services from being received, thereby removing a source of creating awareness of value added services available for redemption at a merchant.

There is thus a need to improve upon the manner in which advertisements of value added services are transmitted to mobile terminals.

### SUMMARY

This section provides a general summary of the disclosure, and is not a comprehensive disclosure of its full scope or all of its features. Aspects and embodiments of the disclosure are also set out in the accompanying claims.

According to a first aspect of the present disclosure, there is provided a method for transmitting data indicative of selected value added services from an offer distribution server to a mobile terminal as selected value added services data, the method comprising: retrieving, from one or more issuer servers, data indicative of one or more value added services, offered by each of the one or more issuer servers, for storage at the offer distribution server as value added services data; receiving, from the mobile terminal, wallet data providing an indication of one or more payment cards stored in the mobile terminal; processing, at the offer distribution server, the wallet data against the value added services data to determine the one or more value added services accessible through the mobile terminal by ascertaining that the one or more payment cards is recognised by the respective issuer server that offers the one or more value added services; extracting, at the offer distribution server, the selected value added services data for transmission to the mobile terminal in response to consolidation of the one or more value added services accessible through the mobile terminal; and transmitting the selected value added services data to the mobile terminal.

According to a second aspect of the present disclosure, there is provided an offer distribution server for transmitting data indicative of selected value added services from the offer distribution server to a mobile terminal as selected value added services data, the offer distribution server comprising: at least one processor; and at least one memory including computer program code; the at least one memory and the computer program code configured to, with the at least one processor, cause the offer distribution server at least to: retrieve, from one or more issuer servers, data indicative of one or more value added services, offered by each of the one or more issuer servers, for storage at the offer distribution server as value added services data; receive, from the mobile terminal, wallet data providing an indication of one or more payment cards stored in the mobile terminal; process the wallet data against the value added services data to determine the one or more value added services accessible through the mobile terminal by ascertaining that the one or more payment cards is recognised by the respective issuer server that offers the one or more value added services; extract the selected value added services data for transmission to the mobile terminal in response to consolidation of the one or more value added services accessible through the mobile terminal; and transmit the selected value added services data to the mobile terminal.

According to a third aspect of the present disclosure, there is provided a non-transitory computer readable medium having stored thereon executable instructions for controlling an offer distribution server to perform steps comprising: retrieving, from one or more issuer servers, data indicative of one or more value added services, offered by each of the one or more issuer servers, for storage at the offer distribution server as value added services data; receiving, from the mobile terminal, wallet data providing an indication of one or more payment cards stored in the mobile terminal; processing the wallet data against the value added services data to determine the one or more value added services accessible through the mobile terminal by ascertaining that the one or more payment cards is recognised by the respective issuer server that offers the one or more value added services; extracting the selected value added services data for transmission to the mobile terminal in response to consolidation of the one or more value added services accessible through the mobile terminal; and transmitting the selected value added services data to the mobile terminal.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, embodiments of the disclosure will be better understood and readily apparent to one of ordinary skill in the art from the following written description, by way of example only, and in conjunction with the drawings, in which:

FIG. 1 shows a method in accordance with one embodiment of the disclosure, for transmitting data indicative of selected value added services from an offer distribution server to a mobile terminal.

FIG. 2 shows a system in which the method shown in FIG. 1 may be implemented.

FIG. 3A shows selected value added services displayed in the mobile terminal of FIG. 2 from applying a first filter mechanism.

FIG. 3B shows selected value added services displayed in the mobile terminal of FIG. 2 from applying a combination of the first filter mechanism used in FIG. 3A and a second filter mechanism.

FIG. 4 shows a schematic of a website that may be hosted at each of the one or more issuer servers of FIG. 2.

FIG. 5 depicts an exemplary computing device which may be used to realise the offer distribution server of FIG. 2.

Corresponding reference numerals generally indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure. And again, like reference numerals and characters in the drawings refer to like elements or equivalents.

Some portions of the description which follows are explicitly or implicitly presented in terms of algorithms and functional or symbolic representations of operations on data within a computer memory. These algorithmic descriptions and functional or symbolic representations are the means used by those skilled in the data processing arts to convey most effectively the substance of their work to others skilled in the art. An algorithm is here, and generally, conceived to be a self-consistent sequence of steps leading to a desired result. The steps are those requiring physical manipulations of physical quantities, such as electrical, magnetic or optical signals capable of being stored, transferred, combined, compared, and otherwise manipulated.

Unless specifically stated otherwise, and as apparent from the following, it will be appreciated that throughout the present specification, discussions utilizing terms such as “scanning”, “calculating”, “determining”, “replacing”, “generating”, “initializing”, “outputting”, “processing”, “deriving” or the like, refer to the action and processes of a computer system, or similar electronic device, that manipulates and transforms data represented as physical quantities within the computer system into other data similarly represented as physical quantities within the computer system or other information storage, transmission or display devices.

The present specification also discloses apparatus for performing the operations of the methods. Such apparatus may be specially constructed for the required purposes, or may comprise a computer or other device selectively activated or reconfigured by a computer program stored in the computer. The algorithms and displays presented herein are not inherently related to any particular computer or other apparatus. Various machines may be used with programs in accordance with the teachings herein. Alternatively, the construction of more specialized apparatus to perform the required method steps may be appropriate. The structure of a conventional computer will appear from the description below.

In addition, the present specification also implicitly discloses a computer program, in that it would be apparent to the person skilled in the art that the individual steps of the method described herein may be put into effect by computer code. The computer program is not intended to be limited to any particular programming language and implementation thereof. It will be appreciated that a variety of programming languages and coding thereof may be used to implement the teachings of the disclosure contained herein. Moreover, the computer program is not intended to be limited to any particular control flow. There are many other variants of the computer program, which can use different control flows without departing from the spirit or scope of the disclosure.

Furthermore, one or more of the steps of the computer program may be performed in parallel rather than sequentially. Such a computer program may be stored on any computer readable medium. The computer readable medium may include storage devices such as magnetic or optical disks, memory chips, or other storage devices suitable for interfacing with a computer. The computer readable medium may also include a hard-wired medium, such as exemplified in the Internet system, or wireless medium, such as exemplified in the GSM mobile telephone system. The computer program when loaded and executed on a computer effectively results in an apparatus that implements the steps of the method(s) herein.

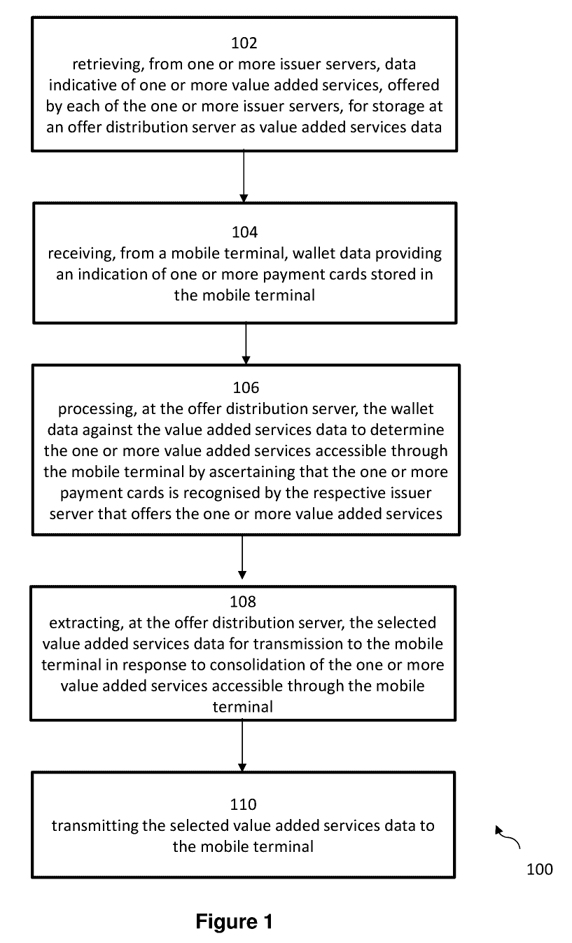

FIG. 1 shows a method 100, in accordance with one embodiment of the disclosure, for transmitting data indicative of selected value added services from an offer distribution server to a mobile terminal as selected value added services data. Accordingly, value added services data refers to encoded data that when processed at the mobile terminal facilitates redemption of the value added service. In the method 100, the value added services that are transmitted to the mobile terminal are selected from a pool of value added services that are stored in the offer distribution server. Typically, the selected value added services which are transmitted form a subset of the value added services stored in the offer distribution server (elaborated further with reference to step 106 shown in FIG. 1), although the selected value added services may encompass all of the stored value added services if it is determined that the user of the mobile terminal is entitled to all of the value added services stored in the offer distribution server.

Value added services, which include any one or more of coupons, offers and loyalty program points, refer to benefits that are associated with purchase of a good or service provided by a merchant. Such benefits may influence the price of a purchased good or service, such as coupons providing an offer or discount off the price; or benefits that follow from the purchase of the good or service, such as coupons exchangeable for a gift, the awarding of membership to a loyalty program, and/or the awarding of reward points to a loyalty program. A loyalty program refers to a structured marketing effort that rewards, and therefore encourages, loyal buying behaviour from the same merchant. In one implementation, value added services are only redeemable at merchants that participate in a promotion that may be initiated by, for example, a bank.

The offer distribution server refers to a single computing device or a plurality of interconnected computing devices which operate together to perform the function of crawling websites that offer value added services. The offer distribution server may be contained within a single hardware unit or be distributed among several or many different hardware units.

The mobile terminal may be a smart phone with an advanced mobile operating system, such as iOS of Apple Inc. or Android of Google Inc. The operating system hosts one or more applications, where one of them is a client application used to allow the mobile terminal to communicate with the offer distribution server during execution of the method 100 of FIG. 1. Another one of these hosted applications may be a digital wallet application, which allows for electronic payment of goods and/or services offered by a merchant.

The method 100 comprises the steps 102, 104, 106, 108 and 110 which are explained in further detail below.

In the step 102, data indicative of one or more value added services is retrieved from one or more issuer servers that offer the one or more value added services. The data indicative of one or more value added services is stored at the offer distribution server as value added services data.

The issuer server refers to a single computing device or a plurality of interconnected computing devices which operate together to perform the function of hosting value added services that can be redeemed at one or more merchants. The issuer server may be contained within a single hardware unit or be distributed among several or many different hardware units. In one implementation, the issuer server is maintained or owned by a financial service provider, such as a bank, that issues payment cards, such as a credit, a debit card or a prepaid card, that is registered to an account holder. Alternatively, if the issuer server belongs to a third party, then the financial service provider owns an account in the third party issuer server. A database of each of the one or more issuer servers stores records of hosted value added services and the one or more merchants at which the value added services can be redeemed. These one or more merchants then become a participant to the value added service scheme, wherein the one or more value added services may be bundled with or tied to one or more payment cards issued by the financial service provider. One or more value added services is then redeemed when the payment card is presented at the respective one or more participating merchants. Each of the one or more issuer servers may store the data of the one or more value added services grouped to the payment card that is entitled to the one or more value added services.

In the step 104, the offer distribution server receives, from the mobile terminal, wallet data providing an indication of one or more payment cards stored in the mobile terminal. This wallet data may be provided by a digital wallet application that is installed in the mobile terminal, such as “MasterPass” by MasterCard®. The digital wallet application acts as a repository or logical container for the payment cards, whereby a selection of one of these payment cards allows the digital wallet application to perform electronic payment of goods and/or services offered by a merchant.

In the step 106, the wallet data from the step 104 is processed at the offer distribution server against the value added services data from the step 102 to determine the one or more value added services accessible through the mobile terminal. This determination is ascertained from the one or more payment cards being recognised by the respective issuer server that offers the one or more value added services. In one implementation, the offer distribution server performs this recognition by establishing which of the one or more payment cards in the mobile terminal is entitled to the one or more value added services by verifying that the payment card is issued by the financial service provider that maintains or owns the issuer server which hosts the one or more value added services. This verification may be done by extracting, from the wallet data, the payment card number (typically a 16 digit number) for each of the one or more payment cards. The identification of the financial service provider may be through analysing the payment card number for the bank identification number (BIN) or the issuer identification number (IIN), which is typically the leading six digits of the payment card number for each of the one or more payment cards. The offer distribution server then queries a BIN database with each of the extracted BIN for a matching entry in the BIN database, which determines the issuer for each of the one or more payment cards. The BIN lookup can also determine the payment card type (such as whether the payment card is a credit card or a debit card), its brand or sub-brand (such as the payment network that is accessed when the payment card is used, e.g. MasterCard®, Amex® or Visa®. On successful verification, one or more value added services are made accessible through the mobile terminal.

In the step 108, the selected value added services data for transmission to the mobile terminal are extracted at the offer distribution server. This extraction or derivation is in response to consolidation of the one or more value added services accessible through the mobile terminal. Thus in step 108, value added services that are not redeemable and therefore not relevant to the user of the mobile terminal are not sent to the mobile terminal. Accordingly, the mobile terminal receives less irrelevant data, which is advantageous in proper utilisation of data bandwidth used by the mobile terminal.

In the step 110, the selected value added services data from the step 108 are transmitted from the offer distribution server to the mobile terminal. The mobile terminal then receives value added services that are redeemable, where such receipt may entice the user of the mobile terminal to spend at the merchant at which the value added service can be redeemed.

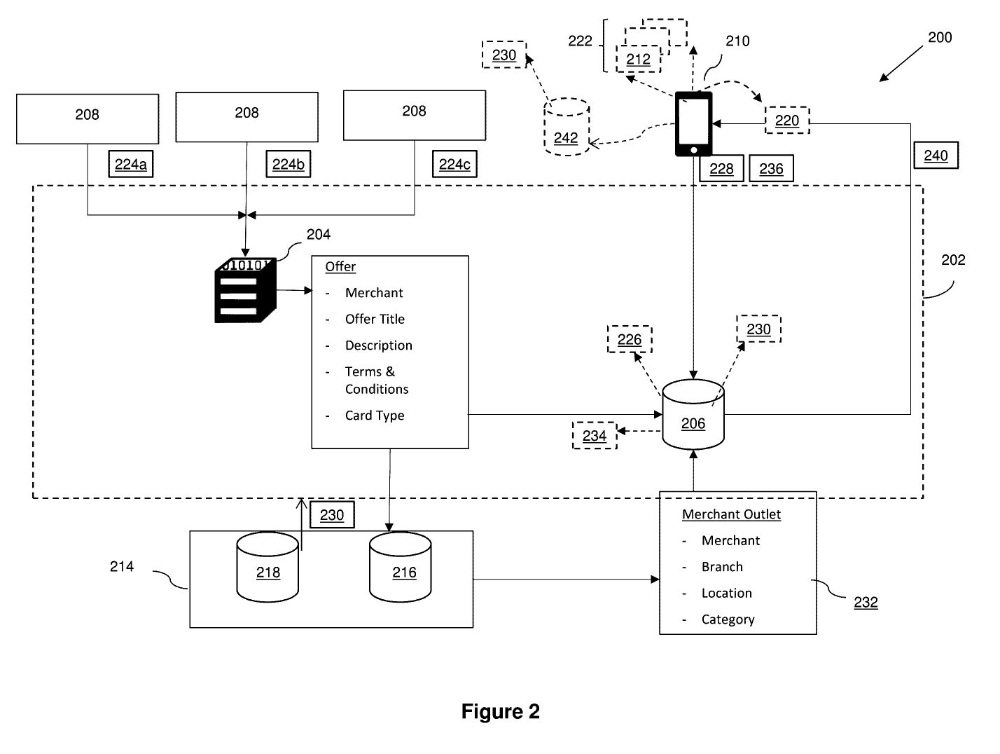

FIG. 2 shows a system 200 in which the method 100 shown in FIG. 1 may be implemented. The system 200 comprises an offer distribution server 202, one or more issuer servers 208, a mobile terminal 210 and an enterprise server 214.

One of the functions of the offer distribution server 202 is to crawl or locate websites that offer value added services to retrieve and store them as value added services data. Another function of the offer distribution server 202 is to store data indicative of an address of one or more merchants at which the value added services are redeemable as merchant address data. Other functions of the offer distribution server 202 will also become apparent from the description below. For the sake of simplicity, only a central processor 204 and a database 206 of the offer distribution server 202 are shown.

The one or more issuer servers 208 store records of hosted value added services and the one or more merchants at which the value added services can be redeemed. In one implementation, each of the one or more issuer servers 208 may be maintained by a financial service provider, such as a bank (e.g. DBS™, Citibank™ and OCBC™). During execution of the step 102 of method 100 of FIG. 1, the offer distribution server 202 accesses the one or more issuer servers 208 to retrieve data 224a, 224b and 224c indicative of one or more value added services offered by each of the one or more issuer servers 208. This data 224a, 224b and 224c is stored at the offer distribution server 202 as value added services data 226 in the database 206.

The mobile terminal 210 may be a smart phone which hosts one or more applications, such as a client application 220 which allows communication between the mobile terminal 210 and the offer distribution server 202. Another one of these hosted applications may be a digital wallet application 222, which allows for electronic payment of goods and/or services offered by a merchant. The digital wallet application 222 acts as a repository for one or more payment cards 212. One or more of these payment cards 212 may be issued by a financial service provider, such as a bank, that maintains or owns at least one of the one or more issuer servers 208.

During execution of the step 104 of method 100 of FIG. 1, the offer distribution server 202 receives wallet data 228 from the mobile terminal 210 via the digital wallet application 222 running in the client application 220. The wallet data 228 provides an indication of the one or more payment cards 212 stored in the mobile terminal 210.

The central processor 204 executes the step 106 of method 100 of FIG. 1 by processing the wallet data 228 against the value added services data 226 to determine the one or more value added services accessible through the mobile terminal 210 by ascertaining that the one or more payment cards 212 is recognised by the respective issuer server 208 that offers the one or more value added services. This recognition is performed by verifying that the payment card 212 is issued by the financial service provider that maintains or owns the issuer server 208 which hosts the one or more value added services. Preferably, this recognition of the one or more payment cards 212 may be performed by matching the BIN for each of the one or more payment cards 212 against an entry in a BIN database to identify the issuer for each of the one or more payment cards 212. This BIN database may be part of the database 206 of the offer distribution server 202. The offer distribution server 202 may communicate with the one or more issuer servers 208 during this verification to determine whether the one or more issuer servers 208 has records of the payment card 212 being registered in their respective database. A successful verification results in the central processor 204 determining the value added services to which each of the one or more payment cards 212 is entitled. The central processor 204 then executes the step 108 of method 100 of FIG. 1 by extracting the selected value added services data 240 for transmission to the mobile terminal 210 in response to consolidation of the one or more value added services accessible through the mobile terminal 210, i.e. all of the value added services to which each of the one or more payment cards 212 is entitled is pooled.

Finally, during execution of step 110 of method 100 of FIG. 1, the selected value added services data 240 is transmitted to the mobile terminal 210.

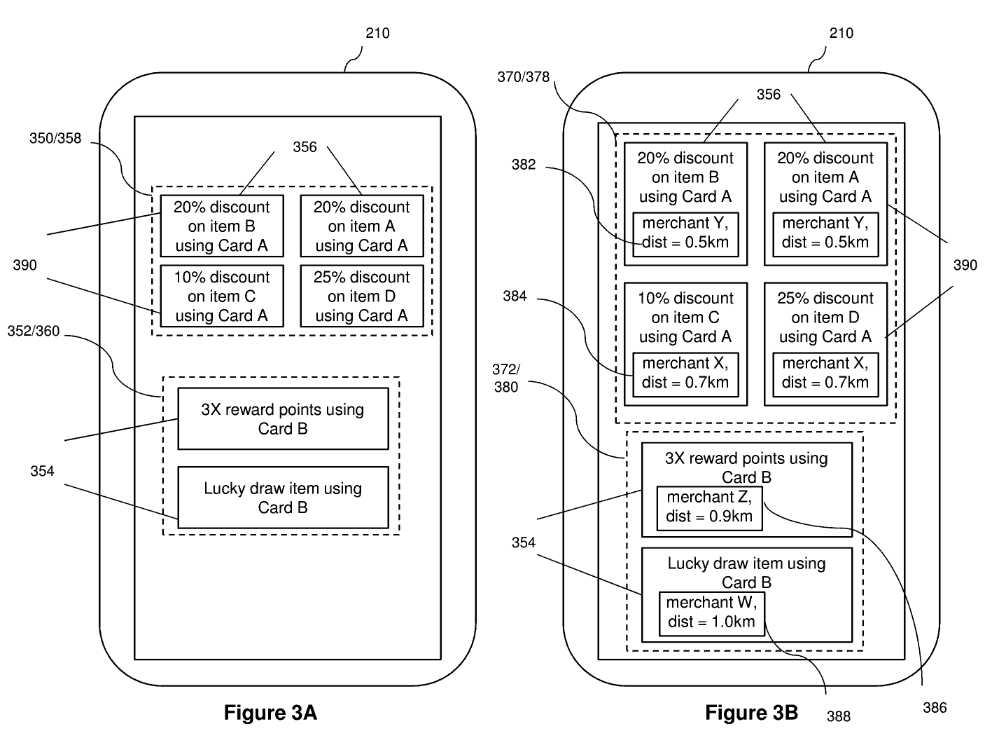

The central processor 204 may also configure the manner in which the selected value added services data 240 received by the mobile terminal 210 is displayed in the mobile terminal 210, so as to facilitate ease of selection. In one implementation, the central processor 204 arranges for the selected value added services data 240 to be displayed, at the mobile terminal 210, in a programmed sequence. In a first embodiment, with reference to FIG. 3A, the one or more value added services 350, 352 that is offered by a same issuer server of the one or more issuer servers 208 is presented in adjacent rows 354, 390 or in adjacent columns 356. In a second embodiment, the one or more value added services 358 for ones of the one or more payment cards that are used more than other ones of the one or more payment cards may be presented first. In the second embodiment, value added services 358 available for more frequently used payment cards are displayed before the value added services 360 available for less frequently used payment cards. The first embodiment can also be combined with the second embodiment, as shown in FIG. 3A, where the value added services 358 for more frequently used payment cards (Card A) are also presented in adjacent rows 390 and columns 356, while the value added services 360 for less frequently used payment cards (Card B) are presented in adjacent rows 354; and value added services 358 available to Card A are shown before the value added services 360 available to Card B.

Returning to FIG. 2, to configure the manner in which the selected value added services data 240 received by the mobile terminal 210 is displayed in the mobile terminal 210, the offer distribution server 202 may retrieve from a transaction database 218 past purchase data 230 providing information of purchase transactions made using the one or more payment cards 212 stored in the mobile terminal 210. The central processor 204 then analyses the past purchase data 230 to extract data indicative of the ones of the one or more payment cards 212 that are used more than other ones of the one or more payment cards 212.

Having the past purchase data 230 hosted at the enterprise server 214 in its transaction database 218 is a first implementation of configuring the manner in which selected value added services is displayed in the mobile terminal 210. A second implementation has such past purchase data 230 hosted at the mobile terminal 210 in its transaction database 242. In this second implementation, the transaction database 242 may be a designated address segment in a memory module of the mobile terminal 210, whereby the designation of this address segment is assigned by the digital wallet application 222. The transaction database 242 is continuously updated for each purchase made using the one or more payment cards 212. The mobile terminal 210 thus does not need to access the enterprise server 214 or any other external device to retrieve past purchase data 230 providing information of purchase transactions made using the one or more payment cards 212, since such past purchase data 230 is stored within the mobile terminal 210. A processor in the mobile terminal 210 retrieves the past purchase data 230 from the transaction database 242 and then analyses the past purchase data 230 to extract data indicative of the payment cards 212 that are more frequently used, i.e. ones of the one or more payment cards 212 that are used more than other ones of the one or more payment cards 212. In a third implementation, past purchase data 230 providing information of purchase transactions is hosted at the offer distribution server 202 in its database 206. The offer distribution server 202 does not need to access the enterprise server 214 or any other external device to retrieve the past purchase data 230, since such past purchase data 230 is stored within the offer distribution server 202. The central processor 204 in the offer distribution server 202 retrieves the past purchase data 230 from its database 206 and then analyses the past purchase data 230 to extract data indicative of the payment cards 212 that are more frequently used, i.e. ones of the one or more payment cards 212 that are used more than other ones of the one or more payment cards 212. In all three implementations, the extracted past purchase data 230 is then used to filter the selected value added services that are shown in the mobile terminal 210.

From the above, it will be appreciated that the selected value added services data 240 that are transmitted from the offer distribution server 202 to the mobile terminal 210 is the result of the method 100 of FIG. 1 performing a first filter of the value added services data 226 that is stored in the database 206 of the offer distribution server 202. One parameter of this first filter is whether the one or more payment cards 212 is recognised by the respective issuer server 208 that offers the one or more value added services.

A second optional filter may be applied on the selected value added services data 240 for transmission to the mobile terminal 210, in addition to the first filter brought about from executing the method 100 of FIG. 1. One parameter of this second filter is the distance between the mobile terminal 210 and a merchant at which one or more of the value added services may be redeemed.

To implement this second filter, the offer distribution server 202 retrieves, from an address database 216, data 232 indicative of an address of one or more merchants at which the value added services are redeemable. This data 232 is stored in the database 206 at the offer distribution server 202 as merchant address data 234. The offer distribution server 202 receives from the mobile terminal 210, mobile location data 236 providing an indication of the location of the mobile terminal 210. The central processor 204 processes the mobile location data 236 against the merchant address data 234 to determine the one or more merchants within a set distance of the mobile terminal 210. The central processor 204 then derives the selected value added services data 240 for transmission to the mobile terminal by further excluding the merchants that are beyond the set distance of the mobile terminal 210.

The central processor 204 may also configure the manner in which the selected value added services data 240 received by the mobile terminal 210 is displayed in the mobile terminal 210, so as to facilitate ease of selection. Thus, when both the second filter and the first filter are applied, the central processor 204 may arrange for the selected value added services data 240 to be displayed, at the mobile terminal 210, in a programmed sequence.

Several realisations of the programmed sequence that follows the approach of combining the second filter with the first filter are shown in FIG. 3B. Similar to the approach of using only the first filter (as shown in FIG. 3A), a first embodiment of the combined approach of the second filter and the first filter has the one or more value added services 370, 372 that is offered by a same issuer server of the one or more issuer servers 208 presented in adjacent rows 354, 390 or adjacent columns 356. In a second embodiment, the one or more value added services 378 for ones of the one or more payment cards 212 that are used more than other ones of the one or more payment cards 212 may be presented first. In the second embodiment, value added services 378 available for more frequently used payment cards are displayed before the value added services 380 available for less frequently used payment cards.

The central processor 204, when executing the combined approach of applying both the second filter and the first filter, has access to additional data, namely that of the merchant address data 234 stored in the database 206 at the offer distribution server 202. The access to this additional data allows for the programmed sequence to be realised in accordance with a third embodiment. In this third embodiment, the selected value added services data 240 is configured to be displayed at the mobile terminal 210 by presenting first the one or more merchants, at which the one or more value added services is redeemable, that are within a set distance of the mobile terminal 210. Such a set distance may be any pre-defined distance that is in the vicinity of the mobile terminal 210, for example around within a 0.5 km to 1.5 km radius of the mobile terminal 210 location. This is illustrated in FIG. 3B, where the value added services 370 redeemable at either merchant Y (see reference numeral 382) or X (see reference numeral 384) are displayed before the value added services 372 redeemable at either merchant Z (see reference numeral 386) or W (see reference numeral 388). Merchant Y, at a distance of 0.5 km from the mobile terminal 210, and merchant X, at a distance of 0.7 km from the mobile terminal 210, are each closer to the mobile terminal 210 than either of merchant Z, at a distance of 0.9 km from the mobile terminal 210 or merchant W, at a distance of 1.0 km from the mobile terminal 210.

The one or more of the first to third embodiments of the approach that employs a combination of the second filter and the first filter can be simultaneously implemented as explained below.

In a first example, the first embodiment can be combined with the second and third embodiments, as shown in FIG. 3B. As shown in FIG. 3B, the one or more value added services 370, 372 that are offered by the same issuer server, are presented in adjacent rows 354, 390 or adjacent columns 356. This can be further filtered by either: presenting first the one or more value added services 378 for the ones of the one or more payment cards that are used more than other ones of the one or more payment cards (in FIG. 3B, Card A is used more frequently than Card B, so the value added services 378 available to Card A are shown before the value added services 380 available to Card B); or presenting first the one or more merchants, at which the one or more value added services is redeemable, that are within a set distance of the mobile terminal 210 (in FIG. 3B, merchant Y and merchant X are each closer to the mobile terminal 210 than either merchant Z or merchant W, so that the value added services 378 redeemable at merchant Y or merchant X are presented before the value added services 380 redeemable at merchant Z or merchant W).

In a second example, the presentation of the one or more value added services for the ones of the one or more payment cards that are used more than other ones of the one or more payment cards can be further filtered by: presenting the one or more value added services, offered by a same issuer server of the one or more issuer servers, in adjacent rows or columns; and/or presenting first the one or more merchants, at which the one or more value added services is redeemable, that are within a set distance of the mobile terminal 210.

In a third example, the presentation of the one or more merchants, at which the one or more value added services is redeemable, that are within a set distance of the mobile terminal can be further filtered by: either presenting the one or more value added services, offered by a same issuer server of the one or more issuer servers, in adjacent rows or columns; and/or presenting first the one or more value added services for the ones of the one or more payment cards that are used more than other ones of the one or more payment cards.

Returning to FIG. 2, to configure the manner in which the selected value added services data 240 received by the mobile terminal 210 is displayed in the mobile terminal 210 (when employing a combination of the second filter and the first filter), the offer distribution server 202 may follow similar methodology as that used when employing only the first filter. Thus, the offer distribution server 202 may retrieve from the transaction database 218 past purchase data 230 providing information of purchase transactions made using the one or more payment cards 212 stored in the mobile terminal 210. The central processor 204 then extracts data indicative of the ones of the one or more payment cards 212 that are used more than other ones of the one or more payment cards 212.

The transaction database 218 from which the past purchase data 230 may be extracted and the address database 216, from which data indicative of the address of one or more merchants at which the value added services are redeemable, may be hosted in the enterprise server 214.

The transaction database 218, accessed when the offer distribution server 202 performs the first filter or a combination of the first filter and the second filter, may be populated with data representing payment device transactions, for example data comprising any one or more of credit card transactions, debit card transactions or stored-value card transactions. As used herein, a “payment device” refers to a suitable transaction card, such as a credit card, a debit card, a prepaid card, a charge card, a membership card, a promotional card, a frequent flyer card, an identification card, a gift card, and/or any other device that may hold payment account information, such as mobile phones, smartphones, personal digital assistants (PDAs), key fobs, and/or computers. Such payment devices are typically uniquely tied to a consumer or card holder account. These transaction records may include the following fields:
Transaction level information:—
   Transaction ID
   Account ID
   Merchant ID
   Transaction Amount
   Transaction Local Currency Amount
   Date of Transaction
   Time of Transaction
   Type of Transaction
   Date of Processing
   Merchant Category Code (MCC)
Account Information (i.e. information about the account holder of the credit card, debit card or stored-value card):—
   Account ID (which may be anonymized)
   Card Group Code
   Card Product Code
   Card Product Description
   Card Issuer Country
   Card Issuer ID
   Card Issuer Name
Merchant Information:—
   Merchant ID
   Merchant Name
   MCC/Industry Code
   Industry Description
   Merchant Country
   Merchant Address
   Merchant Postal Code
   Merchant Acquirer ID (i.e. the identity of the financial institution that pays the merchant when a purchase is made)
Issuer Information (i.e. information about the financial institution that has provided or issued the one or more payment cards 212, such as a credit card, debit card or stored-value card):—
   Issuer ID
   Issuer Name
   Issuer Country

The programmed sequence for either the approach that uses only the first filter or the combined approach, i.e. using both the second filter and the first filter, is configurable through the client application 220, so that the manner in which the selected value added services data 240 is displayed at the mobile terminal 210 can be set by a user of the mobile terminal 210.

Communication between the mobile terminal 210 and the offer distribution server 202 is through the client application 220 installed in the mobile terminal 210. The client application 220 is configured to transmit the data required by the offer distribution server 202 to derive the selected value added services data 240 for transmission to the mobile terminal 210 and receive the selected value added services data 240 from the offer distribution server 202. From the above, the data that the client application 220 may transmit to the offer distribution server 202 includes the wallet data 228 and the mobile location data 236.

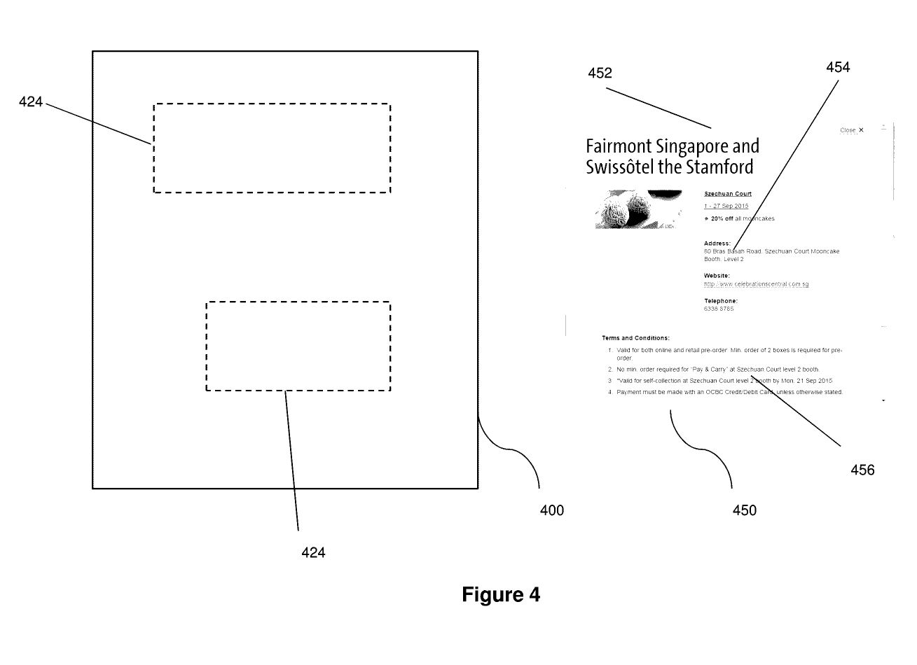

FIG. 4 shows a schematic of a website 400 that may be hosted at each of the one or more issuer servers 208 of FIG. 2. During retrieval of the value added services data 224a, 224b and 224c, the offer distribution server 202 is configured to locate the one or more value added services 424 found in one or more websites 400 hosted at each of the one or more issuer servers 208.

Advertisements for value added services 424, such as coupons, offers and loyalty program points, are typically positioned in the website 400 through programming code that acts as a placeholder. Such a placeholder may, for example, use a pre-defined template to determine the position of the advertised value added services 424. In one embodiment, the offer distribution server 202 may execute a locator program that is able to detect such placeholders from analysing the script used to realise the website 400. This locator program may, for example, be based on natural language processing.

In one example, a HTML template 450 is generated based on a sample offer or advertised value added services 424 on the website 400. The template 450 includes key information such as Merchant Name 452, Offer Title and Description 454 and Terms and Conditions 456. Using the template 450, the locator program scans the source of the website 400 for chunks of HTML code that matches the template 450. Each matched chunk of HTML code contains information of the value added service hosted in the one or more servers 208, which is then saved on the offer distribution server 202.

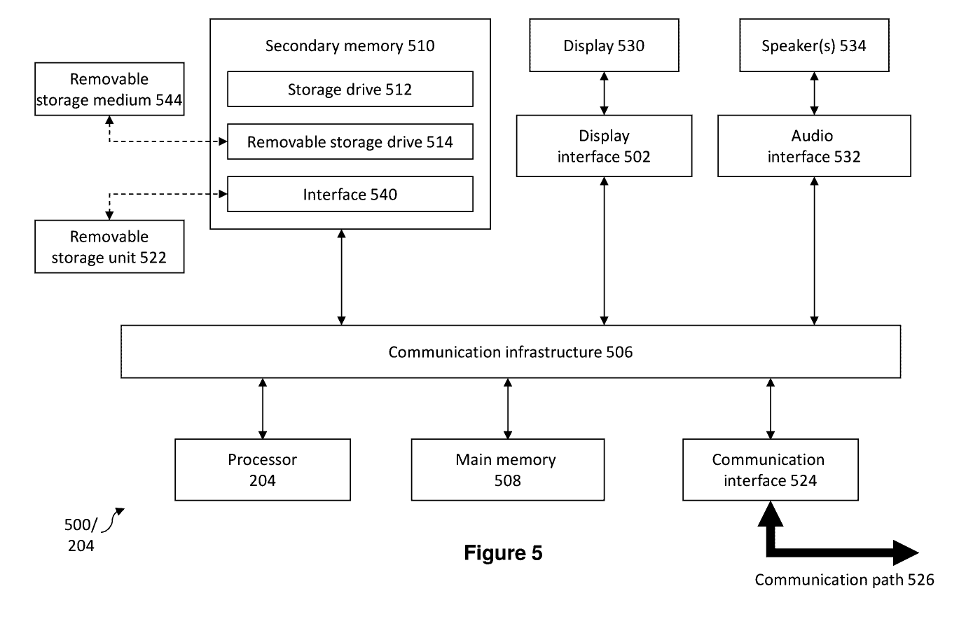

FIG. 5 depicts an exemplary computing device 500, hereinafter interchangeably referred to as a computer system 500, where one or more such computing devices 500 may be used to realise the offer distribution server 202 of FIG. 2. The following description of the computing device 500 is provided by way of example only and is not intended to be limiting.

As shown in FIG. 5, the example computing device 500 includes the processor 204 for executing software routines. Although a single processor is shown for the sake of clarity, the computing device 500 may also include a multi-processor system. The processor 204 is connected to a communication infrastructure 506 for communication with other components of the computing device 500. The communication infrastructure 506 may include, for example, a communications bus, cross-bar, or network.

The computing device 500 further includes a main memory 508, such as a random access memory (RAM), and a secondary memory 510. The secondary memory 510 may include, for example, a storage drive 512, which may be a hard disk drive, a solid state drive or a hybrid drive and/or a removable storage drive 514, which may include a magnetic tape drive, an optical disk drive, a solid state storage drive (such as a USB flash drive, a flash memory device, a solid state drive or a memory card), or the like. The removable storage drive 514 reads from and/or writes to a removable storage medium 544 in a well-known manner. The removable storage medium 544 may include magnetic tape, optical disk, non-volatile memory storage medium, or the like, which is read by and written to by removable storage drive 514. As will be appreciated by persons skilled in the relevant art(s), the removable storage medium 544 includes a computer readable storage medium having stored therein computer executable program code instructions and/or data.

In an alternative implementation, the secondary memory 510 may additionally or alternatively include other similar means for allowing computer programs or other instructions to be loaded into the computing device 500. Such means can include, for example, a removable storage unit 522 and an interface 540. Examples of a removable storage unit 522 and interface 540 include a program cartridge and cartridge interface (such as that found in video game console devices), a removable memory chip (such as an EPROM or PROM) and associated socket, a removable solid state storage drive (such as a USB flash drive, a flash memory device, a solid state drive or a memory card), and other removable storage units 522 and interfaces 540 which allow software and data to be transferred from the removable storage unit 522 to the computer system 500.

The computing device 500 also includes at least one communication interface 524. The communication interface 524 allows software and data to be transferred between computing device 500 and external devices via a communication path 526. In various embodiments of the disclosures, the communication interface 524 permits data to be transferred between the computing device 500 and a data communication network, such as a public data or private data communication network. The communication interface 524 may be used to exchange data between different computing devices 500 which such computing devices 500 form part an interconnected computer network. Examples of a communication interface 524 can include a modem, a network interface (such as an Ethernet card), a communication port (such as a serial, parallel, printer, GPIB, IEEE 1394, RJ45, USB), an antenna with associated circuitry, and the like. The communication interface 524 may be wired or may be wireless. Software and data transferred via the communication interface 524 are in the form of signals which can be electronic, electromagnetic, optical or other signals capable of being received by communication interface 524. These signals are provided to the communication interface via the communication path 526.

As shown in FIG. 5, the computing device 500 further includes a display interface 502 which performs operations for rendering images to an associated display 530 and an audio interface 532 for performing operations for playing audio content via associated speaker(s) 534.

As used herein, the term “computer program product” may refer, in part, to removable storage medium 544, removable storage unit 522, a hard disk installed in storage drive 512, or a carrier wave carrying software over communication path 526 (wireless link or cable) to communication interface 524. Computer readable storage media refers to any non-transitory, non-volatile tangible storage medium that provides recorded instructions and/or data to the computing device 500 for execution and/or processing. Examples of such storage media include magnetic tape, CD-ROM, DVD, Blu-Ray™ Disc, a hard disk drive, a ROM or integrated circuit, a solid state storage drive (such as a USB flash drive, a flash memory device, a solid state drive or a memory card), a hybrid drive, a magneto-optical disk, or a computer readable card such as a PCMCIA card and the like, whether or not such devices are internal or external of the computing device 500. Examples of transitory or non-tangible computer readable transmission media that may also participate in the provision of software, application programs, instructions and/or data to the computing device 500 include radio or infra-red transmission channels as well as a network connection to another computer or networked device, and the Internet or Intranets including e-mail transmissions and information recorded on Websites and the like.

The computer programs (also called computer program code) are stored in main memory 508 and/or secondary memory 510. Computer programs can also be received via the communication interface 524. Such computer programs, when executed, enable the computing device 500 to perform one or more features of embodiments discussed herein. In various embodiments, the computer programs, when executed, enable the processor 204 to perform features of the above-described embodiments. Accordingly, such computer programs represent controllers of the computer system 500.

Software may be stored in a computer program product and loaded into the computing device 500 using the removable storage drive 514, the storage drive 512, or the interface 540. Alternatively, the computer program product may be downloaded to the computer system 500 over the communications path 526. The software, when executed by the processor 204, causes the computing device 500 to perform the method as described in FIG. 1.

It is to be understood that the embodiment of FIG. 5 is presented merely by way of example. Therefore, in some embodiments, one or more features of the computing device 500 may be omitted. Also, in some embodiments, one or more features of the computing device 500 may be combined together. Additionally, in some embodiments, one or more features of the computing device 500 may be split into one or more component parts.

It will be appreciated that the elements illustrated in FIG. 5 function to provide means for performing the method as described with respect to FIG. 1. The offer distribution server 202 comprises: at least one processor 204 and at least one memory 508 including computer program code.

The at least one memory 508 and the computer program code are configured to, with the at least one processor 204, cause the offer distribution server 202 at least to: retrieve, from the one or more issuer servers 208, data 224a, 224b and 224c indicative of one or more value added services, offered by each of the one or more issuer servers 208, for storage at the offer distribution server 202 as value added services data 226. The offer distribution server 202 is further caused to receive, from the mobile terminal 210, wallet data 228 providing an indication of one or more payment cards 212 stored in the mobile terminal 210. The offer distribution server 202 is further caused to process the wallet data 228 against the value added services data 226 to determine the one or more value added services accessible through the mobile terminal 210 by ascertaining that the one or more payment cards 212 is recognised by the respective issuer server 208 that offers the one or more value added services. The offer distribution server 202 is further caused to extract the selected value added services data 240 for transmission to the mobile terminal 210 in response to consolidation of the one or more value added services accessible through the mobile terminal 210 and transmit the selected value added services data 240 to the mobile terminal 210.

The processor 204 may be further configured to perform recognition of the one or more payment cards 212 by matching a banking identification number (BIN) for each of the one or more payment cards 212 against an entry in a BIN database. The processor 204 may be further configured to cause the offer distribution server 202 to retrieve, from the address database 216, data 232 indicative of an address of one or more merchants, at which the value added services are redeemable, for storage as the merchant address data 234. The processor 204 may be further configured to cause the offer distribution server 202 to receive, from the mobile terminal 210, mobile location data 236 providing an indication of the location of the mobile terminal 210. The processor 204 may be further configured to cause the offer distribution server 202 to process the mobile location data 236 against the merchant address data 234 to determine the one or more merchants within a set distance of the mobile terminal 210 so that the derivation of the selected value added services data 240 for transmission to the mobile terminal 210 further comprises excluding the merchants that are beyond the set distance of the mobile terminal 210.

The processor 204 may be further configured to cause the selected value added services data 240 to be displayed, at the mobile terminal 210, in a programmed sequence. The programmed sequence comprises one or more of: presenting the one or more value added services, offered by a same issuer server of the one or more issuer servers 208, in adjacent rows or columns; presenting first the one or more value added services for the ones of the one or more payment cards that are used more than other ones of the one or more payment cards; or presenting first the one or more merchants, at which the one or more value added services is redeemable, that are within the set distance of the mobile terminal.

The processor 204 may be further configured to retrieve, from the transaction database 218, past purchase data providing information of purchase transactions made using the one or more payment cards 212 stored in the mobile terminal 210; and analyse the past purchase data to extract data indicative of the ones of the one or more payment cards that are used more than other ones of the one or more payment cards

The computing device 500 of FIG. 5 may execute the method shown in FIG. 1 when the computing device 500 executes instructions which may be stored in any one or more of the removable storage medium 544, the removable storage unit 522 and storage drive 512. These components 522, 544 and 512 provide a non-transitory computer readable medium having stored thereon executable instructions for controlling the offer distribution server 202, realised by the computing device 500, to perform steps comprising: a) retrieving, from one or more issuer servers 208, data 224a, 224b and 224c indicative of one or more value added services, offered by each of the one or more issuer servers 208, for storage at the offer distribution server 202 as value added services data 226; b) receiving, from the mobile terminal 210, wallet data 228 providing an indication of one or more payment cards 212 stored in the mobile terminal 210; c) processing the wallet data 228 against the value added services data 226 to determine the one or more value added services accessible through the mobile terminal 210 by ascertaining that the one or more payment cards 212 is recognised by the respective issuer server 208 that offers the one or more value added services; d) extracting the selected value added services data 240 for transmission to the mobile terminal 210 in response to consolidation of the one or more value added services accessible through the mobile terminal 210; and e) transmitting the selected value added services data 240 to the mobile terminal 210.

It will be appreciated by a person skilled in the art that numerous variations and/or modifications may be made to the present disclosure as shown in the specific embodiments without departing from the spirit or scope of the disclosure as broadly described. The present embodiments are, therefore, to be considered in all respects to be illustrative and not restrictive.

With that said, it should be appreciated that one or more aspects of the present disclosure transform a general-purpose computing device into a special-purpose computing device when configured to perform the functions, methods, and/or processes described herein.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method for transmitting data indicative of selected value added services from an offer distribution server to a mobile terminal as selected value added services data, the method comprising:
retrieving, from one or more issuer servers, data indicative of one or more value added services, offered by each of the one or more issuer servers, for storage at the offer distribution server as value added services data;
receiving, from the mobile terminal, wallet data providing an indication of one or more payment cards stored in the mobile terminal;
processing, at the offer distribution server, the wallet data against the value added services data to determine the one or more value added services accessible through the mobile terminal by ascertaining that the one or more payment cards is recognised by the respective issuer server that offers the one or more value added services;
extracting, at the offer distribution server, the selected value added services data for transmission to the mobile terminal in response to consolidation of the one or more value added services accessible through the mobile terminal; and
transmitting the selected value added services data to the mobile terminal.

2. The method of claim 1, wherein the recognition of the one or more payment cards is performed by matching a banking identification number (BIN) for each of the one or more payment cards against an entry in a BIN database at the offer distribution server.

3. The method of claim 1, further comprising causing, by the offer distribution server, the selected value added services data to be displayed, at the mobile terminal, in a programmed sequence.

4. The method of claim 3, wherein causing the selected value added services data to be displayed in the programmed sequence comprises one or more of:
presenting the one or more value added services, offered by a same issuer server of the one or more issuer servers, in adjacent rows or columns; or
presenting first the one or more value added services for ones of the one or more payment cards that are used more than other ones of the one or more payment cards.

5. The method of claim 3, further comprising
retrieving, from an address database, data indicative of an address of one or more merchants at which the value added services are redeemable, for storage at the offer distribution server as merchant address data;
receiving, from the mobile terminal, mobile location data providing an indication of the location of the mobile terminal; and
processing, at the offer distribution server, the mobile location data against the merchant address data to determine the one or more merchants within a set distance of the mobile terminal, so that the derivation, at the offer distribution server, of the selected value added services data for transmission to the mobile terminal further comprises excluding the merchants that are beyond the set distance of the mobile terminal.

6. The method of claim 5, wherein causing the selected value added services data to be displayed in the programmed sequence further comprises:
presenting first the one or more merchants, at which the one or more value added services is redeemable, that are within the set distance of the mobile terminal.

7. The method of claim 6, wherein presentation of the one or more value added services, offered by the same issuer server, in adjacent rows or columns is further filtered by either:
presenting first the one or more value added services for the ones of the one or more payment cards that are used more than other ones of the one or more payment cards; or
presenting first the one or more merchants, at which the one or more value added services is redeemable, that are within the set distance of the mobile terminal.

8. The method of claim 6, wherein presentation of the one or more value added services for the ones of the one or more payment cards that are used more than other ones of the one or more payment cards is further filtered by:
presenting the one or more value added services, offered by a same issuer server of the one or more issuer servers, in adjacent rows or columns; and/or
presenting first the one or more merchants, at which the one or more value added services is redeemable, that are within the set distance of the mobile terminal.

9. The method of claim 6, wherein the presentation of the one or more merchants, at which the one or more value added services is redeemable, that are within the set distance of the mobile terminal is further filtered by:
presenting the one or more value added services, offered by a same issuer server of the one or more issuer servers, in adjacent rows or columns; and/or
presenting first the one or more value added services for the ones of the one or more payment cards that are used more than other ones of the one or more payment cards.

10. The method of claim 6, further comprising:
retrieving, from a transaction database, past purchase data providing information of purchase transactions made using the one or more payment cards stored in the mobile terminal; and
analysing the past purchase data to extract data indicative of the ones of the one or more payment cards that are used more than other ones of the one or more payment cards.

11. The method of claim 10, wherein the transaction database and the address database are hosted in an enterprise server.

12. The method of claim 1, wherein communication between the mobile terminal and the offer distribution server is through a client application installed in the mobile terminal, wherein the client application is configured to transmit the data required by the offer distribution server to derive the selected value added services data for transmission to the mobile terminal and receive the selected value added services from the offer distribution server.

13. The method of claim 1, wherein retrieval of the value added services data comprises locating the one or more value added services found in one or more websites hosted at each of the one or more issuer servers; and/or
wherein the one or more value added services comprise any one or more of coupons, offers and loyalty program points.

14. (canceled)

15. An offer distribution server for transmitting data indicative of selected value added services from the offer distribution server to a mobile terminal as selected value added services data, the offer distribution server comprising:
at least one processor; and
at least one memory including computer program code;
the at least one memory and the computer program code configured to, with the at least one processor, cause the offer distribution server at least to:
retrieve, from one or more issuer servers, data indicative of one or more value added services, offered by each of the one or more issuer servers, for storage at the offer distribution server as value added services data;
receive, from the mobile terminal, wallet data providing an indication of one or more payment cards stored in the mobile terminal;
process the wallet data against the value added services data to determine the one or more value added services accessible through the mobile terminal by ascertaining that the one or more payment cards is recognised by the respective issuer server that offers the one or more value added services;
extract the selected value added services data for transmission to the mobile terminal in response to consolidation of the one or more value added services accessible through the mobile terminal; and
transmit the selected value added services data to the mobile terminal.

16. The offer distribution server of claim 15, wherein the at least one processor is further configured to perform recognition of the one or more payment cards by matching a banking identification number (BIN) for each of the one or more payment cards against an entry in a BIN database.

17. The offer distribution server of claim 15, wherein the at least one processor is further configured to:
retrieve, from an address database, data indicative of an address of one or more merchants, at which the value added services are redeemable, for storage as merchant address data;
receive, from the mobile terminal, mobile location data providing an indication of the location of the mobile terminal; and
process the mobile location data against the merchant address data to determine the one or more merchants within vicinity set distance of the mobile terminal so that the derivation of the selected value added services data for transmission to the mobile terminal further comprises excluding the merchants that are beyond the set distance of the mobile terminal.

18. The offer distribution server of claim 17, wherein the at least one processor is further configured to cause for the selected value added services data to be displayed, at the mobile terminal, in a programmed sequence.

19. The offer distribution server of claim 18, wherein the programmed sequence comprises one or more of:
presenting the one or more value added services, offered by a same issuer server of the one or more issuer servers, in adjacent rows or columns;
presenting first the one or more value added services for the ones of the one or more payment cards that are used more than other ones of the one or more payment cards; or
presenting first the one or more merchants, at which the one or more value added services is redeemable, that are within the set distance of the mobile terminal.

20. The offer distribution server of claim 19, wherein the at least one processor is further configured to:
retrieve, from a transaction database, past purchase data providing information of purchase transactions made using the one or more payment cards stored in the mobile terminal; and
analyse the past purchase data to extract data indicative of the ones of the one or more payment cards that are used more than other ones of the one or more payment cards.

21. A non-transitory computer readable medium having stored thereon executable instructions for controlling an offer distribution server, which when executed, cause the offer distribution server to:
retrieve, from one or more issuer servers, data indicative of one or more value added services, offered by each of the one or more issuer servers, for storage at the offer distribution server as value added services data;
receive, from the mobile terminal, wallet data providing an indication of one or more payment cards stored in the mobile terminal;
process the wallet data against the value added services data to determine the one or more value added services accessible through the mobile terminal by ascertaining that the one or more payment cards is recognised by the respective issuer server that offers the one or more value added services;
extract the selected value added services data for transmission to the mobile terminal in response to consolidation of the one or more value added services accessible through the mobile terminal; and
transmit the selected value added services data to the mobile terminal.
